(19) United States
(12) Patent Application Publication
(10) Pub. No.: US 2006/0129528 A1
(43) Pub. Date: Jun. 15, 2006

(54) Database load reducing system and load reducing program

(76) Inventors: Daisuke Miyamoto, Tokyo (JP); Satoshi Abe, Tokyo (JP)

Correspondence Address: CANTOR COLBURN, LLP, 55 GRIFFIN ROAD SOUTH, BLOOMFIELD, CT, 06002, US

(21) Appl. No.: 10/541,928

(22) PCT Filed: Jan. 14, 2003
(86) PCT No.: PCT/JP03/00221

§ 371 Date: Jul. 11, 2005

(51) Int. Cl. G06F 17/30

(52) U.S. Cl. 707/3

(57) ABSTRACT

An object of the present invention is to provide a database load alleviation system and load alleviation program which balance load by interpreting queries and distributing queries which enable load balancing to database servers. In a database load alleviation system, a query-interpretive load balancer 1 interprets queries received from a user terminal 10, and judges whether the queries enable load balancing. Queries enabling load balancing are each distributed in sequence to one among the database servers 2-1 to 2-n in accordance with a load balancing algorithm, to balance the load. On the other hand, in the case of queries which do not enable load balancing such as a query which performs data writing, the query is replicated, and replicas are transmitted to all database servers 2-1 to 2-n, to maintain database consistency.

### TECHNICAL FIELD

The present invention relates to a database load alleviation system, and in particular is related to a database load alleviation system and load alleviation program which alleviate the load by interpreting queries and sequentially distributing the queries to a plurality of database servers.

### BACKGROUND ART

With the spread of the Internet in recent years, there has been a rapid increase in the number of persons using databases over computer networks. When numerous queries from users are sent to databases, the load on the server providing the database increases, so that performance of the server declines, and the processing time from the time a query is issued until the query results are obtained becomes longer. In particular, when synchronous access is used as access to a database, the time until acquisition of a query result and advance to the next processing is lengthened, and operability is degraded. Hence technology is needed to alleviate the load on the database server and efficiently process the queries from numerous users.

Conventionally, one method for alleviating loads on database servers entails installation of a plurality of database servers, and distributing queries to any one among the plurality of database servers, to suppress the loads on each database server (see for example Non-patent document 1). In order to synchronize and maintain consistency among contents of a plurality of databases when using this method, a file server may be used; each of the database servers shares a database installed in the file server, so that consistency of the contents can be maintained.

In the above-described conventional method of distributing queries, when queries for adding new data or queries for performing update procedure are distributed to only one server among the plurality of database servers, the contents of the databases provided by the different database servers become different, and so there is the problem that consistency among the databases cannot be maintained. Further, when using a file server in order to maintain consistency, the load is concentrated on the file server which causes the databases to have common contents, and so the performance of the system providing the database declines. In order to avoid such a decline in performance, there is the problem that a huge amount of resources must be provided for the file server.

### DISCLOSURE OF THE INVENTION

An object of the present invention is to provide a database load alleviation system and load alleviation program which interprets queries from users to database servers, divides the queries into types, performs effective load balancing by distribution to a plurality of database servers in the case of queries which enable load balancing, and in the case of queries such as for data writing which are not suited to perform load balancing, executes the queries on all database servers to maintain consistency among the databases.

The gist of the present invention is a database load alleviation system, comprising a plurality of database servers; and a load alleviation device which manages the plurality of database servers, wherein the load alleviation device comprises: a query interpretation unit which interprets received queries, and judges whether the queries enable load balancing of the database servers; a query distribution unit which sequentially distributes and transmits to the database servers, those queries judged by the query interpretation unit to enable load balancing; a replication unit which replicates those queries judged by the query interpretation unit not to enable load balancing; and a query transmission unit which transmits to all managed database servers, queries replicated by the replication unit.

The above configuration is appropriate for realization of balancing of the load on database servers and maintenance of the consistency of a plurality of database servers.

Further, the gist of the present invention is the above-described database load alleviation system, in which the query interpretation unit judges whether the received queries match a regular expression which reads data, and in the case of the regular expression which performs reading, judges the queries to be queries which enable load balancing.

Further, the gist of the present invention is the above-described database load alleviation system, in which the query distribution unit uses a predetermined load alleviation algorithm to select one server among the plurality of database servers, in order and in looping fashion, for distribution of a query judged by the query-interpretation unit to enable load balancing.

Further, the gist of the present invention is the above-described database load alleviation system, in which the query execution unit transmits the queries replicated by the replication unit to all the database servers in sequence, starting from a database server to which a next received query which enables load balancing is to be distributed, following a previously distributed query.

As explained above, according to the present invention, queries are interpreted, and in the case of queries enabling load balancing, the queries are distributed to a plurality of database servers in sequence in accordance with a load-balancing algorithm such as round-robin method to balance the load; whereas in the case of queries requiring processing to write to a database, the queries are transmitted to and executed by all database servers, so that database consistency is maintained while balancing the load. Hence declines in the performance of database servers due to increases in the load can be prevented, and there is the further advantage that database reliability can be preserved.

### BRIEF DESCRIPTION OF THE DRAWINGS

FIG. 1 is a conceptual diagram showing an embodiment of the present invention; and,

FIG. 2 is a conceptual diagram showing the processing of an “update” statement or similar.

### BEST MODE FOR CARRYING OUT THE INVENTION

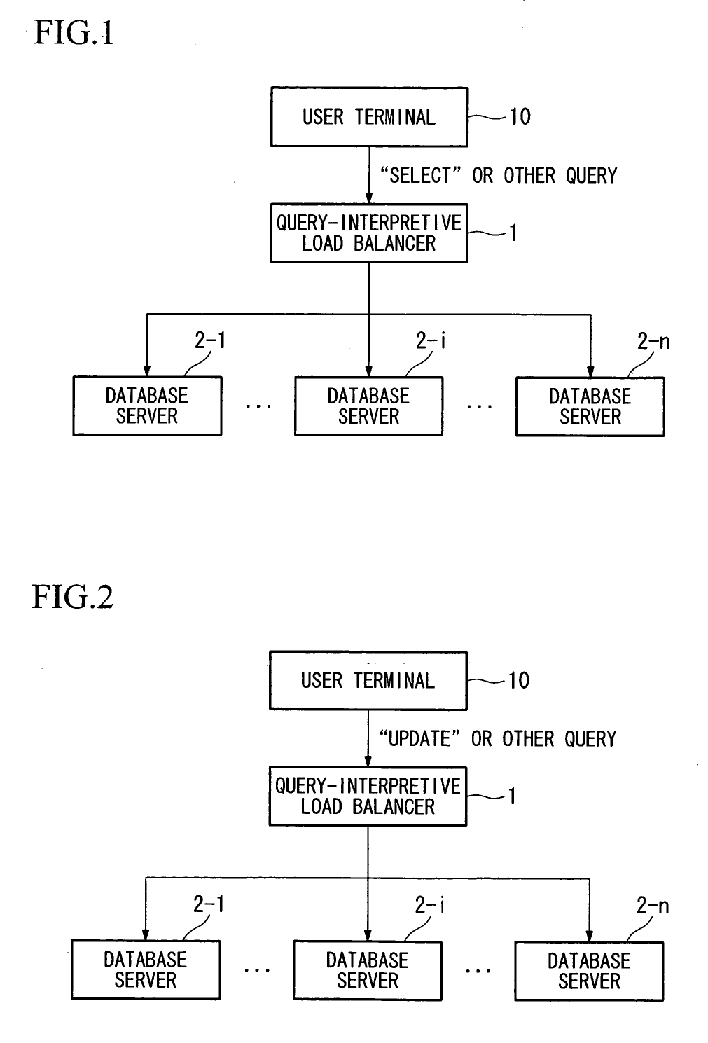

Below, an embodiment of the present invention is explained referring to the drawings. FIG. 1 is a conceptual diagram showing the embodiment of the present invention. In the figure, symbols 2-1 to 2-n (where n is a positive integer) are database servers providing a database. The number of database servers 2-1 to 2-n is determined based on the required load alleviation rate, calculated taking the number of queries into consideration. The symbol 1 denotes a load alleviation device (hereafter called a query-interpretive load balancer) which interprets queries received from a user terminal 10, and distributes and transmits each query to one among the database servers 2-1 to 2-n, or transmits the query to all the database servers 2-1 to 2-n.

The query-interpretive load balancer 1 interprets a query from the user terminal 10, and judges whether the query enables load balancing. Here, a query addressed to a database server is assumed to be written in SQL (Structured Query Language), which is the most widespread programming language for database manipulation. The query-interpretive load balancer 1 focuses on the content of the SQL code to make a judgment. For example, a database reference-type query represented by a “select” statement, etc., performs database reading, and so is judged to be a query enabling load balancing.

The following is an example of a regular expression of a Postgre SQL “select” statement.

ˆQ[\tΔ]*select[\tΔ]+.*;$

In Postgre SQL, The leading “ˆ” of the SQL statement is followed by the query-identifying character “Q”, to declare that the statement is a query. As in the above example, after the “Q” the “select” statement follows. A space or TAB may be inserted between the “Q” and the “select” statement. In order to judge that the query enables load balancing, this regular expression is used to decide whether the query is a reference-type query which only references the database, as expressed by a “select” statement or similar.

Queries sent to the above-described query-interpretive load balancer 1 are not queries with a special structure; queries intended for ordinary database servers can be used.

Other types of queries which do not match this regular expression, for example, update-type queries expressed using “update”, “insert”, “delete”, or other statements which change data in the database, perform writing to the database, and so are interpreted as queries which cannot be used in load balancing. An example of Postgre SQL is shown, but there are no limitations on the language of use, and other languages may be used.

The query-interpretive load balancer 1 employs a predetermined existing load balancing algorithm (a round-robin method, weighted priority order method, number-of-connections method, response time method, HTTP (Hyper Text Transfer Protocol) header method, or an algorithm which combines these, or similar), such as a round-robin method, to distribute queries judged to enable load balancing to the database servers 2-1 to 2-n. In round-robin distribution, one among the database servers 2-1 to 2-n is selected in ascending order, and in looping fashion, for query distribution. In the case of a query not enabling load balancing, the query is replicated to generate n queries (the number of database servers), and these queries are transmitted for execution to all the database servers 2-1 to 2-n. The queries are transmitted to all the database servers 2-1 to 2-n in sequence, beginning from the database server to which a next received query enabling load balancing is to be distributed, following the query previously distributed in accordance with a round-robin method. The query-interpretive load balancer 1 also transmits one confirmation data item, among the similar confirmation data items indicating the end of processing in response to the queries transmitted from each of the database servers 2-1 to 2-n, such as for example the confirmation data item received last from the database servers 2-1 to 2-n, to the user terminal 10.

Next, operation of the embodiment of the present invention is explained referring to FIG. 1. First, a query input from the user terminal 10 is sent via a communication network to the query-interpretive load balancer 1. The query-interpretive load balancer 1 interprets the query, and judges whether the query matches the regular expression of a “select” statement or other reference-type query. If the query does so match, the query is judged to be a query enabling load balancing, and is sent in accordance with a round-robin method. In round-robin distribution, one among the database servers 2-1 to 2-n is selected sequentially in ascending order, and queries are distributed and transmitted.

Upon receiving a query, a database server, such as for example database server 2-i, executes the query and returns the query result to the user terminal 10 through the interpretive load balancer 1. If after transmitting the query to the database server the query-interpretive load balancer 1 does not acquire a query result, despite the predetermined time having elapsed, the query is distributed to the next database server in order.

The load balancing effect of distribution of queries comprising “select” statements to a plurality of database servers as described above is evaluated by measuring the load on the CPU (Central Processing Unit) of the database servers; according to these results, when all queries are reference types employing “select” statements or similar, when there are two database servers (n=2), it is found that the CPU utilization rate is improved by an average of approximately 60%.

On the other hand, when a query does not match a regular expression of a “select” statement, and is judged to be a query not enabling load balancing, the query is replicated to generate n queries. FIG. 2 shows processing for the case in which the query is an “update” statement. One of the replicated queries is first transmitted to the database server to which the query enabling load balancing to be received next would have been distributed, following the query previously distributed in accordance with a round-robin method. Then, the queries are transmitted to all the database servers 2-1 to 2-n in sequence. If there is no response to the query even when a predetermined time has elapsed after transmission of the query, execution advances to the next database server.

1. A database load alleviation system comprising:
a plurality of database servers; and
a load alleviation device which manages the plurality of database servers,
wherein the load alleviation device comprises:
a query interpretation unit which interprets received queries, and judges whether the queries enable load balancing of the database servers;
a query distribution unit which sequentially distributes and transmits to the database servers, those queries judged by the query interpretation unit to enable load balancing;
a replication unit which replicates those queries judged by the query interpretation unit not to enable load balancing; and
a query transmission unit which transmits to all managed database servers, queries replicated by the replication unit.

2. The database load alleviation system according to claim 1, wherein the query interpretation unit judges whether the received queries match a regular expression which reads data, and in the case of the regular expression which performs reading, judges the queries to be queries which enable load balancing.

3. The database load alleviation system according to claim 1, wherein the query distribution unit uses a predetermined load alleviation algorithm to select one server among the plurality of database servers, in order and in looping fashion, for distribution of a query judged by the query interpretation unit to enable load balancing.

4. The database load alleviation system according to claim 1, wherein the query transmission unit transmits the queries replicated by the replication unit to all the database servers in sequence, starting from a database server to which a next received query which enables load balancing is to be distributed, following a previously distributed query.

5. A load alleviation program, in a database load alleviation system comprising a plurality of database servers and a load alleviation device which manages the plurality of database servers, causing a computer to execute:
a function of interpreting received queries and judging whether the queries enable load balancing of the database servers;
a function of distributing and transmitting those queries judged to enable load balancing in sequence to the database servers in accordance with a load balancing algorithm;
a function of replicating those queries judged not to enable load balancing; and
a function of transmitting replicated queries to all managed database servers.
